(19) United States
(12) Patent Application Publication
(10) Pub. No.: US 2011/0044673 A1
(43) Pub. Date: Feb. 24, 2011

(54) ZOOM LENS AND IMAGE PICKUP APPARATUS

(76) Inventors: Daiki Kawamura, Saitama-shi (JP); Kenichi Sato, Saitama-shi (JP)

Correspondence Address: BIRCH STEWART KOLASCH & BIRCH, PO BOX 747, FALLS CHURCH, VA, 22040-0747, US

(21) Appl. No.: 12/860,369

(22) Filed: Aug. 20, 2010

(30) Foreign Application Priority Data
Aug. 21, 2009 (JP) P2009-191953

(51) Int. Cl. G02B 15/14; G03B 17/00

(52) U.S. Cl. 396/72; 359/676

(57) ABSTRACT

Provided is a photographic lens which prevents lenses disposed in the front and the rear of a prism from physically interfering with each other and in which the optical axes of the prism and the lenses disposed in the front and the rear of the prism are precisely aligned with each other. A photographic lens is a zoom lens that deflects the optical path of a prism and performs zooming by moving a second lens group and a third lens group disposed in the rear of the prism. A notch having a circular shape is formed on the prism side of a negative lens adjacent to the prism along the outer periphery of the lens. During zooming, when the second lens group is moved to the position close to the prism, the edge of the second lens group is fitted into the notch.

### CROSS-REFERENCE TO RELATED APPLICATIONS

This application is based upon and claims the benefit of priority from the Japanese Patent Application No. 2009-191953 filed on Aug. 21, 2009; the entire contents of which are incorporated herein by reference.

### BACKGROUND OF THE INVENTION

1. Field of the Invention

The present invention relates to a zoom lens and an image pickup apparatus equipped with the zoom lens. Specifically, the invention relates to a zoom lens, which takes an image by deflecting light originated from a subject through a prism and performs zooming by moving the lens disposed in the rear of the prism and the like, and an image pickup apparatus using the same.

2. Description of the Related Art

Digital cameras for taking an image of a subject by using image pickup devices such as the CCD and the like have come into widespread use. Recently, digital cameras miniaturized to improve portability have spread, and particularly, thin-card-type digital cameras have spread. Further, digital cameras are mounted in small-size portable apparatuses such as a laptop computer and a cellular phone, and there is a demand to achieve further reduction in size and thickness.

As a known photographic lens mounted in small and thin digital cameras, there is a photographic lens configured to be housed in a thin and narrow space by deflecting the optical path thereof by 90 degrees through a prism. In the photographic lens that deflects the optical path through a prism as described above, a lens, which is disposed in the front (subject side) of the prism, and a lens, which is disposed in the rear (image side) of the prism, are disposed to be perpendicular to each other. Hence, sometimes, the lenses, which are disposed in the front and the rear of the prism, or members, which support the lenses, may physically interfere with each other. In this point of view, there are known photographic lenses which are configured to avoid the physical interference between the lenses in a way that the outer peripheral portions of the lenses disposed in the front and the rear of the prism are partly notched and are formed in a non-rotationally symmetric shape (Japanese Patent No. 4016211, and JP-A-2005-128065).

Further, in the photographic lens that deflects the optical path through a prism, there is a known example in which the notch is formed on a lens and the lens having a non-rotationally symmetric shape is used for a purpose other than the purpose of avoiding the physical interference between the lenses disposed in the front and the rear of the prism. For example, an increase in diameter of the lens disposed in the rear of the prism may interfere with reduction in thickness of the digital camera. For this reason, there is a known photographic lens which achieves reduction in thickness in a way that the lens disposed in the rear of the prism is provided with a notch along the direction of the long side of the screen so as to be adjusted to the rectangular screen and is formed in a so-called oval shape (JP-A-2005-121799).

### SUMMARY OF THE INVENTION

However, when the non-rotationally symmetric lens of which the outer peripheral portion has the notch formed thereon is used in the photographic lens as described above, it may be difficult to obtain a desired optical performance. For example, the front and rear surface of the lens may be eccentric, or manufacturing errors such as assembly errors and processing errors of members which support lenses may occur. At this time, the lenses constituting the photographic lens may be rotationally symmetric lenses. In this case, at the time of the assembly of the photographic lens, by rotating the lenses constituting the photographic lens respectively, the above-mentioned errors are reduced. In such a manner, it is possible to embody a photographic lens capable of achieving more desirable optical performance. However, when the non-rotationally symmetric lens is used in the photographic lens, arrangement of lenses is restricted by the shape and the directivity of the notch. For this reason, it may be difficult to perform fine adjustment using rotation of rotationally symmetric lenses about the optical axis as the center, and thus it may also be difficult to obtain desirable optical performance.

Further, in the photographic lens which deflects the optical path by 90 degrees through a prism, accuracy of the alignment between the optical axis of the prism and the optical axes of the lenses disposed in the front and the rear of the prism has great influence on the optical performance. However, in order to avoid the physical interference between the lenses disposed in the front and the rear of the prism, the non-rotationally symmetric lenses, of which the outer peripheral portions have the notches formed thereon, may be disposed in the front and the rear of the prism. In this case, the relative positional relationship between the lenses and the prism is determined by the positions and the shapes of the notches. Hence, it is difficult to perform the above-mentioned alignment of the optical axes using the rotation of the lenses, and it is difficult to obtain desirable optical performance.

The invention has been made in view of the above-mentioned points, and in the photographic lenses which deflect the optical path through the prism, it is desirable to provide a photographic lens which is configured so as to have a short length as a whole by preventing the lenses disposed in the front and the rear of the prism from physically interfering with each other and in which the optical axes of the prism and the lenses disposed in the front and the rear of the prism are precisely aligned with each other at the time of the assembly. Further, it is also desirable to provide an image pickup apparatus having the photographic lens.

According to an embodiment of the invention, provided is a zoom lens that deflects an optical path by using a reflective member and performs zooming by moving a lens group disposed in the rear of the reflective member. In the zoom lens, a notch is formed on a reflective member side of a lens adjacent to the reflective member along an outer periphery of the lens. Furthermore, “the reflective member side” means a part including the surface facing the reflective member in the thickness direction. Further, the lens is originally formed in a circular shape which is symmetric about the optical axis as the center, and “along the outer periphery” means that it is formed along the edge of the original circular shape of the lens.

Further, it is preferable that the notch should be formed on the lens which is disposed to be adjacent to the front of the reflective member.

Furthermore, it is preferable that the notch should be formed on the lens which is disposed to be adjacent to the rear of the reflective member.

Further, it is preferable that only one negative lens should be disposed in the front of the reflective member.

Furthermore, it is preferable that the zoom lens should include a first lens group that includes the reflective member and a stationary lens which is disposed to remain stationary relative to an optical axis and is positioned to be closest to a subject side. In addition, it is also preferable that the first lens group should have a negative refractive power as a whole.

Further, it is preferable that the zoom lens should include a second lens group that is provided in the rear of the reflective member so as to be movable relative to the optical axis. In addition, it is also preferable that the second lens group should have a positive refractive power as a whole.

Furthermore, it is preferable that a photographic screen should be rectangular, and the reflective member should deflect the optical path in a direction perpendicular to the short sides of the photographic screen.

Further, it is preferable that the photographic screen should be rectangular, and the zoom lens should include a lens of which an outer peripheral portion is cut off along the sides of the photographic screen, and is formed in a non-rotationally symmetric shape.

Furthermore, it is preferable that the zoom lens should include, in order from the subject side: the first lens group that has a negative refractive power and includes the reflective member; the second lens group that has a positive refractive index; a third lens group that has a negative refractive power; and a fourth lens group that has a positive refractive index. In addition, it is also preferable that zooming should be performed by moving the second lens group and the third lens group along an optical axis.

Further, according to another embodiment of the invention, an image pickup apparatus includes the above-mentioned zoom lens.

As a result, according to the embodiments of the invention, in photographic lenses that deflect the optical path through a prism, it is possible to provide a photographic lens which is configured so as to have a short length as a whole by preventing the lenses disposed in the front and the rear of the prism from physically interfering with each other and in which the optical axes of the prism and the lenses disposed in the front and the rear of the prism are precisely aligned with each other at the time of the assembly. Further, by employing the photographic lens, it is possible to provide an image pickup apparatus reduced in size and thickness.

### BRIEF DESCRIPTION OF THE DRAWINGS

FIG. 1 is an explanatory diagram illustrating an exterior view of a digital camera and disposition of a photographic lens;

FIG. 2 is a sectional view illustrating a configuration of the photographic lens;

FIGS. 3A and 3B are explanatory diagrams illustrating a shape of a notch;

FIGS. 4A and 4B are explanatory diagrams illustrating an example in which the notch is formed on the lens in the rear of the prism;

FIG. 5 is an explanatory diagram illustrating an example in which the appearance of the lens is formed to be non-rotationally symmetric in accordance with a photographic screen;

FIGS. 6A and 6B are explanatory diagrams illustrating different shapes of the notch;

FIGS. 7A and 7B are sectional views of a photographic lens according to Example 1;

FIGS. 8A and 8B are sectional views of a photographic lens according to a modified example of Example 1;

FIGS. 9A and 9B are sectional views of a photographic lens according to Example 2;

FIGS. 10A and 10B are sectional views of a photographic lens according to Example 3; and

FIGS. 11A and 11B are sectional views of a photographic lens according to Example 4.

### DESCRIPTION OF THE PREFERRED EMBODIMENTS

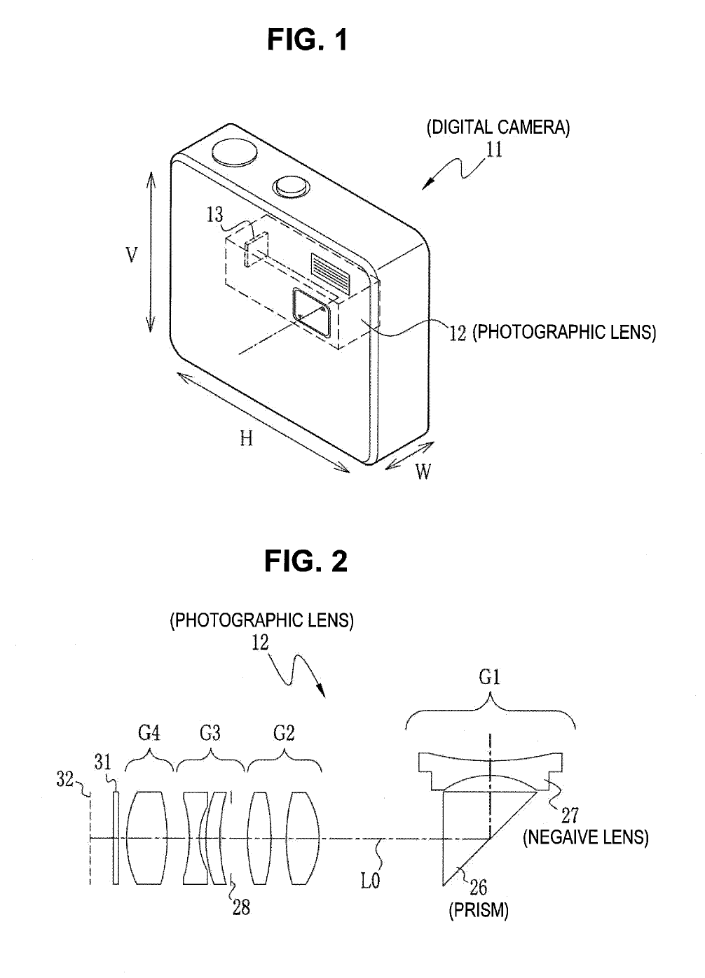

As shown in FIG. 1, a digital camera (an image pickup apparatus) 11 is a digital camera that acquires image data of a subject by performing photoelectric conversion of light which is originated from the subject, and includes a photographic lens 12, an image pickup device 13, and the like. The digital camera 11 is a thin digital camera, in which the size thereof is small in the thickness direction (the W direction) as compared with the size in the vertical direction (the V direction) or the horizontal direction (the H direction). The front surface of the digital camera 11 is formed in a substantially rectangular shape, in which the size thereof in the H direction is longer than that in the V direction. Further, in the photographic screen of the digital camera 11, the size thereof in the H direction is longer than that in the V direction.

The image pickup device 13 is provided on the rear end of the photographic lens 12, and performs photoelectric conversion of an image which is formed on the image pickup surface 14 having a rectangular shape through the photographic lens 12, thereby outputting the image data of the subject. Further, the image pickup device 13 is disposed so that the direction of the long side of the image pickup surface 14 is parallel with the W direction and the direction of the short side thereof is parallel with the V direction.

The photographic lens 12 is a lens that deflects the optical path of the light, which is incident from the subject, in the H direction by 90 degrees and thereby forms an image on the image pickup surface 14. In addition, the photographic lens 12 is housed in a rectangular parallelepiped casing, and is disposed horizontally in the digital camera 11 so that the long side thereof is along the H direction. Further, the photographic lens 12 is a so-called zoom lens, and performs zooming by moving the lenses or lens groups constituting the photographic lens 12 and changing the lens space. Furthermore, the lens, which is disposed to be closest to the subject side, among the lenses constituting the photographic lens 12 is exposed on the front surface of the digital camera 11 in the range of a rectangular shape, of which the size in the H direction is longer than that in the V direction, in accordance with the photographic screen.

As shown in FIG. 2, the photographic lens 12 includes the first to fourth lens groups G1 to G4 in order from the front side (the subject side) thereof. The first lens group G1 is a lens group, which is disposed to be closest to the subject side, among the lens groups G1 to G4 constituting the photographic lens 12. In addition, the first lens group G1 is formed of a prism (a reflective member) 26 which deflects the optical path by 90 degrees and a negative lens (a first lens) 27 which is disposed in the front of the prism 26. Further, all the lenses and the like constituting the first lens group G1 are disposed to remain stationary relative to an optical axis L0.

The second lens group G2 includes a plurality of lenses, is disposed in the rear (the image side) of the first lens group G1, and is provided to be movable along the optical axis L0. The photographic lens 12 moves the second lens group G2 and the third lens group G3 to be described later along the optical axis L0, and adjusts the spaces between the lens groups G1 to G4 constituting the photographic lens 12, thereby performing zooming. For example, the photographic lens 12 is in the wide-angle end state and has a minimum focal length when the second lens group G2 is moved to a position farthest from the first lens group G1. Further, the photographic lens 12 is in the telephoto end state and has a maximum focal length when the second lens group G2 is moved to a position closest to the first lens group G1.

The third lens group G3 includes an aperture stop 28 and a plurality of lenses, and is provided in the rear of the second lens group G2 so as to be movable along the optical axis L0. Further, as described above, the third lens group G3 is moved in conjunction with the movement of the second lens group G2, and takes charge of the zooming of the photographic lens 12.

The fourth lens group G4 is disposed to be closest to the image side, and disposed to remain stationary relative to the optical axis L0. Further, the fourth lens group G4 has a positive refractive power as a whole, and forms an image of light, which is originated from the subject, on an image pickup surface 32 through a cover glass 31 of the image pickup device 13.

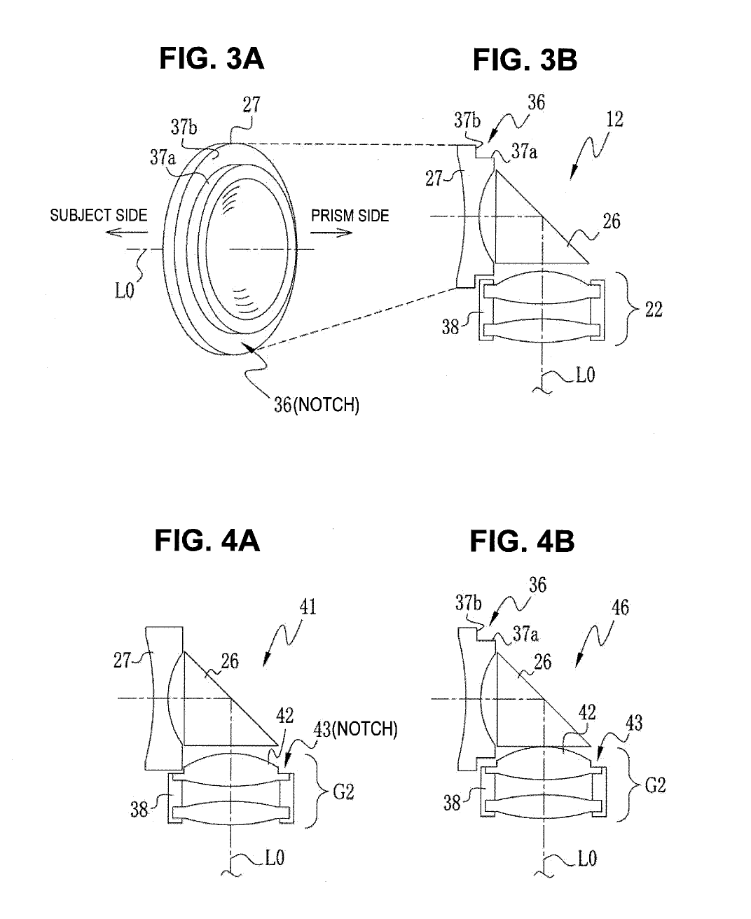

The photographic lens 12 is configured as described above, and a notch is formed on the prism 26 side of at least one lens among the lenses, which are disposed to be adjacent to the prism 26 in the front and the rear of the prism 26, along the outer periphery of the lens. For example, as shown in FIG. 3A, in the photographic lens 12, a notch 36 is formed on the outer peripheral portion of the negative lens 27. The notch 36 is formed on the outer peripheral portion on the prism 26 side of the negative lens 27, and is formed by an annular sectional surface 37a which is substantially perpendicular to the diameter direction of the negative lens 27 and an annular sectional surface 37b which is substantially parallel to the diameter direction of the negative lens and is substantially perpendicular to the optical axis L0.

Further, as shown in FIG. 3B, the size (the length of the sectional surface 37b thereof in the diameter direction) of the notch 36 in the diameter direction and the size (the length of the sectional surface 37a in the direction of the optical axis L0) thereof in the direction of the optical axis L0 are formed as sizes which allow the edge of the second lens group G2 to be able to be fitted into the notch 36 when the second lens group G2 is moved to the position closest to the prism 26. Accordingly, the size of the notch 36 in the diameter direction is determined in accordance with the diameter of the second lens group G2 and the thickness of a supporting member 38 which supports the second lens group G2. In addition, when the second lens group G2 is moved to the position closest to the prism 26, the size of the notch 36 in the diameter direction is formed as a size which does not allow the edge of the second lens group G2 including the supporting member 38 to physically interfere with the edge of the negative lens 27 and allows it to be fitted into the notch 36. Likewise, the size of the notch 36 in the direction of the optical axis L0 is determined in accordance with the diameter of the second lens group G2. In addition, when the second lens group G2 is moved to the position closest to the prism 26, the size of the notch 36 in the direction of the optical axis L0 is formed as a size which does not allows the edge of the second lens group G2 including the supporting member 38 to physically interfere with the edge of the negative lens 27 and allows it to be fitted into the notch 36.

In such a manner, by providing the notch 36 on the negative lens 27, it is possible to move the second lens group G2 to a position close to the prism 26 without colliding with the negative lens 27. Hence, the zoom ratio of the photographic lens 12 is large as compared with a general photographic lens having the same total length, and the total length of the photographic lens 12 is short as compared with a general lens having the same zoom ratio.

Furthermore, the notch 36 is formed in a circular shape along the outer periphery, and has an isotropic shape relative to the negative lens 27. Hence, it is not necessary to dispose the negative lens 27 by adjusting the position and the direction of the notch 36 relative to the second lens group G2. Accordingly, when assembling the photographic lens 12, it is possible to rotate the negative lens 27 about the optical axis L0 so as to make the optical axis L0 of the negative lens 27 coincide with the optical axis L0 of the prism 26 as accurate as possible, and it is possible to further improve optical performance of the photographic lens 12.

Furthermore, in the above-mentioned embodiment, description has been given of the example in which the notch 36 is formed on the outer peripheral portion of the negative lens 27 which is disposed to be adjacent to the front side of the prism 26. However, the notch 36 may be formed on the outer peripheral portion of the lens which is disposed to be adjacent to the rear side of the prism 26, and may be formed on both of the lens which is disposed to be adjacent to the front side of the prism 26 and the lens which is disposed to be adjacent to the rear side of the prism 26.

For example, similarly to a photographic lens 41 shown in FIG. 4A, the notch 36 is not formed on the negative lens 27, but a notch 43 may be formed on the prism 26 side of a lens 42 (the second lens), which is disposed to be adjacent to the prism 26, among the lenses of the second lens group G2 along the outer periphery thereof. In this case, similarly to the notch 36 formed on the negative lens 27, the notch 43 is formed in a shape and with a size which does not allow the negative lens 27 and the lens 42 to physically interfere with each other by moving the second lens group G2. In such a manner, even when the notch 43 is formed on the lens 42 which is disposed to be adjacent to the rear side of the prism 26, similarly to the case where the notch 36 is formed on the negative lens 27 which is disposed to be adjacent to the front side of the prism 26, the photographic lens 12 can be configured so that the zoom ratio thereof is large and the total length thereof is short. Further, in the same manner as described above, when assembling the photographic lens 12, it is possible to rotate the negative lens 27 or the second lens group G2 (the lens 42) about the optical axis L0 so as to make the optical axis L0 of the negative lens 27 or the second lens group G2 coincide with the optical axis L0 of the prism 26 as accurate as possible, free from the shape of the notch 43. Thus, it is possible to further improve optical performance of the photographic lens 41.

Further, for example, similarly to a photographic lens 46 shown in FIG. 4B, the notches 36 and 43 may be respectively formed on both of the negative lens 27 which is disposed in the front of the prism 26 and the lens 42 which is disposed to be adjacent to the prism 26 in the rear of the prism 26. In this case, as compared with the case where the notch 36 or 43 is formed on only one of the negative lens 27 and the lens 42, it is possible to move the second lens group G2 to the position closer to the prism 26. Hence, when notches 36 and 43 are formed on both of the negative lens 27 and the lens 42, the photographic lens 46 can be configured so that the zoom ratio thereof is larger and the total length thereof is shorter than that of the photographic lenses 12 and 41.

Furthermore, in the photographic lens mounted in the thin digital camera 11, the outer peripheral portion of the lens is cut off along the direction of the long side and the direction of the short side of the rectangular photographic screen, and the lens is formed in a so-called oval shape or a rectangular shape. In such a manner, it is possible to achieve reduction in size and thickness of the photographic lens. As described above, even when the lens formed in the oval shape is used, in the same manner as described in the above-mentioned embodiment, it is preferable that the notch should be formed on the prism 26 side of at least one lens of the lenses, which are disposed to be adjacent to the front and the rear of the prism 26, along the outer periphery thereof.

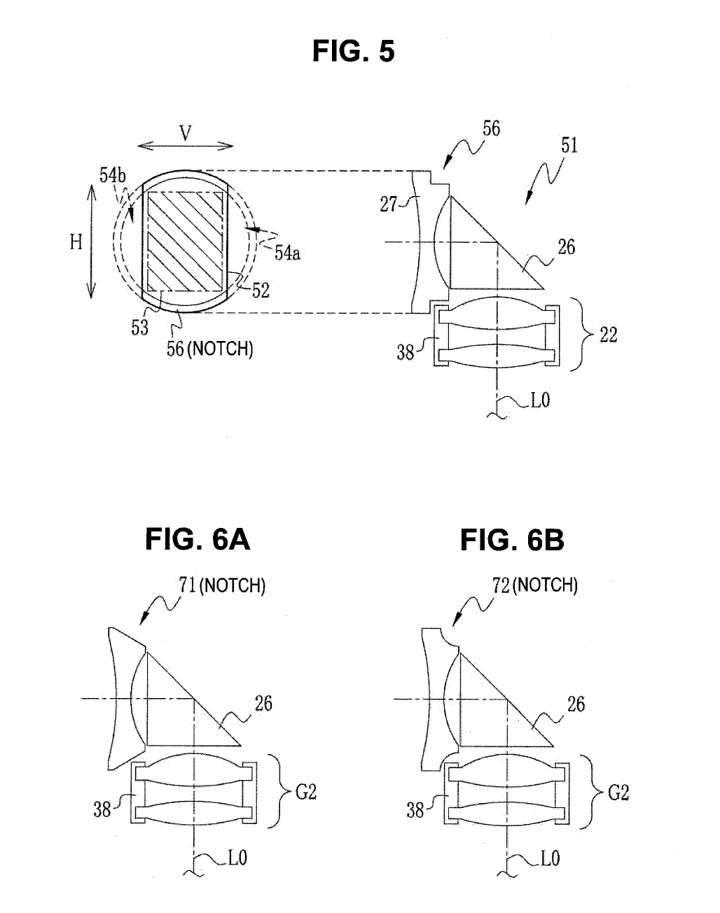

For example, as shown in FIG. 5, similarly to the photographic lens 12 according to the above-mentioned embodiment, a photographic lens 51 includes the first to fourth lens groups G1 to G4, and is disposed to be closest to the subject side, but the shape of a negative lens 52, which is exposed on the front surface of the digital camera 11, is different as compared with the photographic lens 12. In the same manner as described above, the photographic screen of the digital camera 11 is long in the H direction, and is short in the V direction. Hence, the negative lens 52 is formed in an oval shape by cutting off redundant portions 54a and 54b, through which rays of a photographic screen 53 are not transmitted, along the direction of the long side of the rectangular shape corresponding to the photographic screen 53. Simultaneously, a notch 56 is formed on the prism 26 side of the negative lens 52 in a circular shape along the outer periphery thereof. The notch 56 is formed in the same manner as the notch 36 in the above-mentioned embodiment except that the redundant portions 54a and 54b are cut off.

As described above, when the negative lens 52 is formed in the oval shape, it is possible to suppress the thickness of the photographic lens 51 in the V direction, but it is difficult to reduce the size of the photographic lens 51 in the H direction. However, since the notch 56 is formed on the outer peripheral portion of the prism 26 side of the negative lens 52, similarly to the photographic lens 12 according to the above-mentioned embodiment, it is possible to move the second lens group G2 to the position close to the prism 26. Thereby, as compared with a general photographic lens having the same zoom ratio, it is possible to reduce the total length of the photographic lens 51, and it is possible to reduce the size thereof in the H direction. Simultaneously, since the notch 56 is formed in a circular shape along the outer periphery, it is possible to dispose the negative lens 52 by rotating it about the optical axis L0 so as to make the optical axis L0 of the prism 26 coincide with the optical axis L0 of the negative lens 52 as accurate as possible, free from the shape of the notch 56. Thus, it is possible to further improve optical performance of the photographic lens 51.

Further, in the thin digital camera 11, by forming the lens, which is disposed in the rear of the prism 26, in an oval shape in the same manner as described above, the size of the photographic lens 12 may be reduced in the V direction or the W direction. Even in this case, in the same manner as described above, it is preferable that the notch for avoiding the physical interference should be formed on the outer peripheral portion of at least one of the lenses which are disposed in the front and the rear of the prism 26. Also in this case, by reducing the total length of the photographic lens, it is possible to reduce the size thereof in the H direction. Further, it is possible to dispose the lenses in the front and the rear of the prism 26 by rotating those so as to make the optical axes of the lenses accurately coincide with that of the prism, and it is possible to improve optical performance thereof.

Further, in the above-mentioned embodiment, description has been given of the example in which the photographic lens 12 is disposed horizontally in the digital camera 11 so that the lengthwise direction of thereof corresponds to the H direction. However, the invention is not limited to this, and the photographic lens may be disposed vertically so that the lengthwise direction thereof is parallel with the V direction. In this case, in the same manner as the above-mentioned embodiment, by providing the notch on the outer peripheral portion of at least one lens of the lenses disposed to be adjacent to the prism 26 in the front and the rear of the prism 26, it is possible to reduce the total length thereof, and it is possible to increase the zoom ratio thereof. Further, it is possible to dispose the lenses or lens groups which are disposed in the front and the rear of the prism 26 by rotating those about the optical axis L0, and it is possible to improve optical performance of the photographic lens.

Further, in the same manner as described above, even when the lenses constituting the photographic lens 12 are formed in the oval shape, the photographic lens 12 may be disposed vertically. However, as described above, the lens may be formed in a non-rotationally symmetric shape by cutting off the redundant portions of the lens. In this case, the case where the photographic lens 12 is disposed vertically is better than the case where the photographic lens 12 is disposed horizontally in that it is possible to further reduce the total length thereof and increase the zoom ratio thereof by providing the notch on the outer peripheral portions of the lenses disposed to be adjacent to the prism 26 in the front and the rear of the prism 26. For example, the photographic lens 12 may be formed in the oval shape by cutting off portions of the negative lens 27 in the V direction. In this case, when the photographic lens 12 is disposed vertically, the edge of the lens, which is disposed in the rear of the prism 26, becomes close to the portions (the cut-off portions) of the negative lens 27 in the V direction. In contrast, when the photographic lens 12 is disposed horizontally, the edge of the lens, which is disposed in the rear of the prism 26, becomes close to the portions (the non-cut-off portions) of the negative lens 27 in the H direction. Hence, when the photographic lens 12 is disposed horizontally, by providing the notch on the negative lens 27 or the lens 42 of the second lens group G2, it is possible to increase a distance by which the second lens group G2 can be made to be close to the prism 26.

Furthermore, in the above-mentioned embodiment, description has been given of the example in which the second lens group G2 as a movable group is disposed in the rear of the prism 26, but the invention is not limited to this. For example, a stationary lens may be disposed in the rear of the prism 26. In this case, the first lens group G1 includes a stationary lens which is disposed in the rear of the prism 26, and the above-mentioned negative lens 27 and prism 26. When the stationary lens is disposed to be adjacent to the rear side of the prism 26 in such a manner, the negative lens 27 in the front of the prism 26 physically interferes with the edge of the stationary lens, thereby making it difficult to reduce the total length of the photographic lens. Hence, when the stationary lens is disposed in the rear of the prism 26, the notch the same as that in the above-mentioned embodiment may be disposed on at least any one of the outer peripheral portion of the stationary lens and the outer peripheral portion of the negative lens 27 in the front of the prism 26.

Further, in the above-mentioned embodiment, description has been given of the example in which the photographic lens 12 includes the first to fourth lens groups G1 to G4. However, the photographic lens may include three or less lens groups, and the photographic lens may include five or more lens groups. Further, even when the photographic lens 12 has the four-group configuration similarly to the above-mentioned embodiment, the configurations of the respective lens groups are determined optionally. For example, in the above-mentioned embodiment, description has been given of the example in which only one negative lens 27 is disposed in the front of the prism 26, but the invention is not limited to this. For example, a plurality of lenses having an optional refractive power which is a positive or negative power may be disposed in the front of the prism 26.

Furthermore, in the above-mentioned embodiment, description has been given of the examples of the notches 36 and 43 each of which is formed by notching the outer peripheral portion of the lens by a right angle so as to form the sectional surface perpendicular to the diameter of the lens and the sectional surface perpendicular to the optical axis L0 of the lens. However, the shapes of the notches 36 and 43 are not limited to this if only those are rotationally symmetric shapes capable of avoiding the physical interference between the lenses in the front and the rear of the prism 26. For example, similarly to a notch 71 shown in FIG. 6A, the outer peripheral portion of the lens may be formed in a taper shape by being obliquely cut off. In addition, similarly to the notch 72 shown in FIG. 6B, the outer peripheral portion of the lens may be formed in a shape in which the section of the lens has a certain radius of curvature.

Further, in the above-mentioned embodiment, description has been given of the example in which the notches 36 and 43 are formed on the entire circumference of the lens. However, the notches 36 and 43 have only to be formed in the circular shape along the outer periphery of the lens, and each notch may be formed in an arc shape on a portion of the outer periphery of the lens. For example, the notch is formed in an arc shape on only the half or the quarter of the outer periphery of the lens.

Hereinafter, specific examples of the photographic lens 12, that is, Examples 1 to 4 are described with reference to lens data and the like. In Examples 1 to 4, the respective surfaces of the lenses and the like including surfaces of a cover glass 31, which is disposed on the front surface of the image pickup device 13, are represented by surface Si, where i is the surface number in order from the subject side. Further, the space on the optical axis between the surface Si and the surface Si+1, which is the surface adjacent to the image side of the surface Si, is represented by Di. The lens data of the respective examples, such as radii of curvatures R (mm) of the surfaces Si, on-axis surface spacings Di (mm), refractive indices Nd at the d-line, and Abbe numbers νd, are shown in tables. Further, the zoom data, such as focal lengths f at the wide-angle end and telephoto end, FNos., angles of view 2ω (degrees), and variable on-axis surface spacings (mm), are shown in tables. In addition, in lens data, each surface having * attached thereto is an aspheric surface, and the specific shape is represented by the following Numerical Expression 1 on the basis of the depth of the aspheric surface Z (mm), the distance h (mm) from the optical axis to the lens surface, the conic coefficient KA, the paraxial radius of curvature c, and the i-th order aspheric surface coefficient RAi.

$$Z = \frac{{ch}^{2}}{1 + \sqrt{1 - KA \cdot {c}^{2} {h}^{2}}} + {\sum }_{i = 3}^{10} {RA}_{i} \cdot {h}^{i} \qquad Numerical Expression 1$$

### Example 1

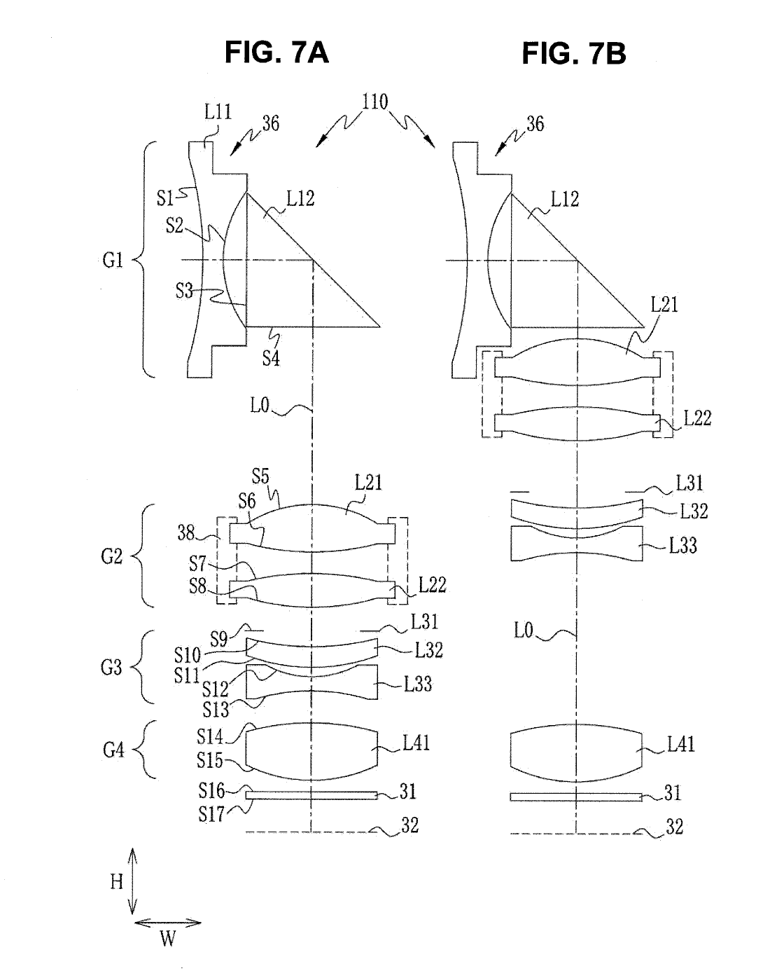

In Example 1, a notch is formed on the prism side of the negative lens, which is disposed in the front of the prism, along the outer periphery thereof, and the movable lens is disposed just behind the prism. As shown in FIGS. 7A and 7B, the photographic lens 110 according to Example 1 includes four lens groups of the first to fourth lens groups G1 to G4. FIG. 7A shows arrangement of the lens groups G1 to G4 at the wide-angle end, and FIG. 7B shows arrangement of the lens groups G1 to G4 at the telephoto end. Further, Table 1 shows lens data of the photographic lens 110 according to Example 1, Table 2 shows zoom data, and Table 3 shows aspheric surface coefficients.

TABLE 1
EXAMPLE 1 • BASIC LENS DATA

| | Ri | Di | Nd | νd |
|---|---|---|---|---|
| Si | (RADIUS | (ON-AXIS | (REFRAC- | (ABBE |
| (SURFACE | OF CUR- | SURFACE | TIVE | NUM- |
| NUMBER) | VATURE) | SPACING) | INDEX) | BER) |
| *1 | −3.8668 | 0.22 | 1.51537 | 63.3 |
| *2 | 1.2100 | 0.25 | | |
| 3 | ∞ | 1.43 | 1.78590 | 44.2 |
| 4 | ∞ | D4 | | |
| | | (VARIABLE) | | |
| *5 | 1.2917 | 0.50 | 1.47136 | 76.6 |
| *6 | −2.7359 | 0.23 | | |
| 7 | 2.9791 | 0.36 | 1.49700 | 81.5 |
| 8 | −2.4583 | D8 | | |
| | | (VARIABLE) | | |
| 9 (APERTURE | ∞ | 0.17 | | |
| STOP) | | | | |
| *10 | −2.7153 | 0.22 | 1.62041 | 60.3 |
| *11 | −1.9944 | 0.10 | | |
| 12 | −1.0137 | 0.15 | 1.84665 | 23.8 |
| 13 | 2.0968 | D13 | | |
| | | (VARIABLE) | | |
| *14 | 2.5804 | 0.61 | 1.80348 | 40.4 |
| *15 | −1.5827 | 0.12 | | |
| 16 | ∞ | 0.08 | 1.51680 | 64.2 |
| 17 | ∞ | 0.35 | | |

(*ASPHERIC SURFACE)

TABLE 2
EXAMPLE 1 • ZOOM DATA

| | f | FNo. | 2ω | D4 | D8 | D13 |
|---|---|---|---|---|---|---|
| WIDE-ANGLE END | 1.00 | 3.19 | 64.7 | 1.90 | 0.25 | 0.34 |
| TELEPHOTO END | 2.85 | 5.27 | 23.4 | 0.12 | 0.55 | 1.83 |

TABLE 3
EXAMPLE 1 • ASPHERIC SURFACE DATA

| ASPHERIC | | | | |
|---|---|---|---|---|
| SURFACE | | | | |
| COEFFICIENT | L11 | L21 | L31 | L41 |
| | FIRST SURFACE(S1) | FIFTH SURFACE(S5) | TENTH SUSFACE(S10) | FOURTEENTH SUSFACE(S14) |
| KA | 1.0001604 | 0.9908239 | 1.0003388 | 0.999918 |
| RA₃ | — | — | 8.8359644E−03 | — |
| RA₄ | 2.5666643E−03 | −1.1530386E−01 | 1.3375792E+00 | −5.1952400E−02 |
| RA₅ | — | — | 1.8635785E+00 | — |
| RA₆ | −5.9324663E−02 | −9.5841609E−02 | −1.5337276E+00 | 2.0960154E−01 |
| RA₇ | — | — | −9.1859942E+00 | — |
| RA₈ | 4.8494794E−02 | −9.4942008E−02 | −1.1314036E+01 | −3.6416183E−01 |
| RA₉ | — | — | 1.7593200E+01 | — |
| RA₁₀ | −1.4532951E−02 | −7.5491468E−02 | 1.2121454E+02 | 2.1394048E−01 |
| | SECOND SURFACE(S2) | SIXTH SURFACE(S6) | ELEVENTH SURFACE(S11) | FIFTEENTH SURFACE(S15) |
| KA | 0.9501507 | 1.0011668 | 0.9937730 | 0.9974847 |
| RA₃ | — | — | −4.5832778E−04 | — |
| RA₄ | −9.3618354E−02 | 5.2314032E−02 | 1.8893626E+00 | 8.9993699E−02 |
| RA₅ | — | — | 1.4196860E+00 | — |
| RA₆ | −1.7725830E−01 | −5.4788575E−02 | −1.4340081E+00 | 2.2769245E−01 |
| RA₇ | — | — | −7.6519782E−03 | — |
| RA₈ | 1.1905086E−01 | −3.4103119E−01 | 4.9800100E+00 | −4.7806622E−01 |
| RA₉ | — | — | 2.6909074E+00 | — |
| RA₁₀ | −4.7828456E−02 | 4.9375180E−01 | −2.5528690E+01 | 2.9182601E−01 |

As shown in FIGS. 7A and 7B and Tables 1 to 3, the first lens group G1 includes, in order from the subject side: a lens L11 which has a negative refractive power; and a prism L12, and the refractive power of the first lens group G1 is negative as a whole. The notch 36 is formed on the prism L12 side of the lens L11 in a circular shape along the outer periphery thereof. Further, the first lens group G1 is a stationary lens group, and the lens L11 and the prism L12 are disposed to remain stationary relative to the optical axis L0.

The second lens group G2 is disposed in the rear of the prism L12, and includes two lenses of the lenses L21 and L22 which are disposed in order from the subject side. All the refractive powers of the lenses L21 and L22 are positive. Hence, the refractive power of the second lens group G2 is positive as a whole. Further, the second lens group G2 is a movable lens group which is provided to be movable along the optical axis L0. At the wide-angle end, the second lens group G2 is moved to the position closest to the image side from the prism L12, and at the telephoto end, it is moved to the position closest to the prism L12.

The third lens group G3 includes, in order from the subject side, three elements of: an aperture stop L31; a lens L32 which has a positive refractive power; and a lens L33 which has a negative refractive power, and the refractive power of the third lens group G3 is negative as a whole. Further, the third lens group G3 is a movable lens group which is provided to be movable along the optical axis L0. At the wide-angle end, the third lens group G3 is moved to the position closest to the image side, and at the telephoto end, it is moved to the position closest to the prism L12 side. By being moved as described above, the third lens group G3 takes charge of zooming of the photographic lens 110 together with the second lens group G2.

The fourth lens group G4 includes a lens L41 which has a positive refractive power. Hence, the refractive power of the fourth lens group G4 is positive. Further, the fourth lens group G4 is a stationary lens group, and the lens L41 is disposed to remain stationary relative to the optical axis L0.

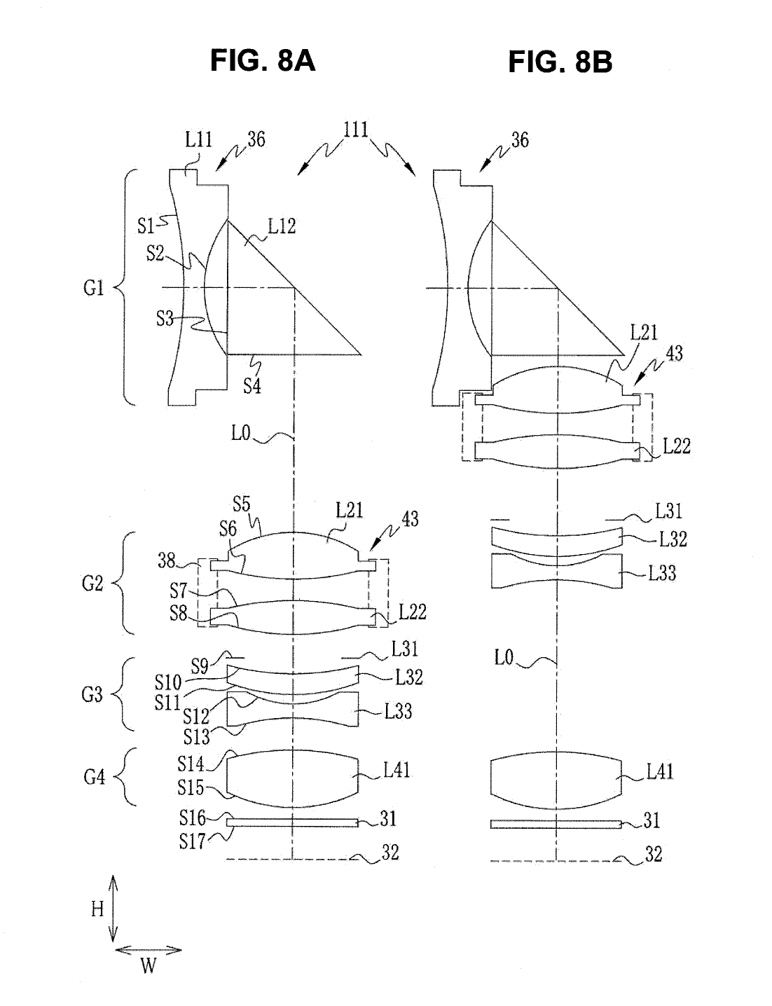

Furthermore, in the photographic lens 110, the notch 36 is formed only on the lens L11 which is the stationary lens. However, the notch 36 may be formed not only on the lens L11 but also on the lens L21 which is provided to be movable along the optical axis L0. For example, in configurations of the lens groups G1 to G4 and shapes of the lens surfaces (Tables 1 to 3), the photographic lens 111 shown in FIGS. 8A and BE is the same as the photographic lens 110 according to the above-mentioned Example 1. The photographic lens 111 is different from the above-mentioned photographic lens 110 in the following points: the notch 36 is formed on the lens L11; the notch 43 is formed on the prism L12 side of the lens L21 along the outer periphery thereof; and the notch 43 is made to be fitted into the notch 36 when the second lens group G2 is moved to the telephoto end. Hence, the depth of the notch 36, which is formed on the lens L11, is different between the photographic lens 110 and the photographic lens 111. Further, FIG. 8A shows arrangement of the lens groups G1 to G4 at the wide-angle end, and FIG. 8B shows arrangement of the lens groups G1 to G4 at the telephoto end.

### Example 2

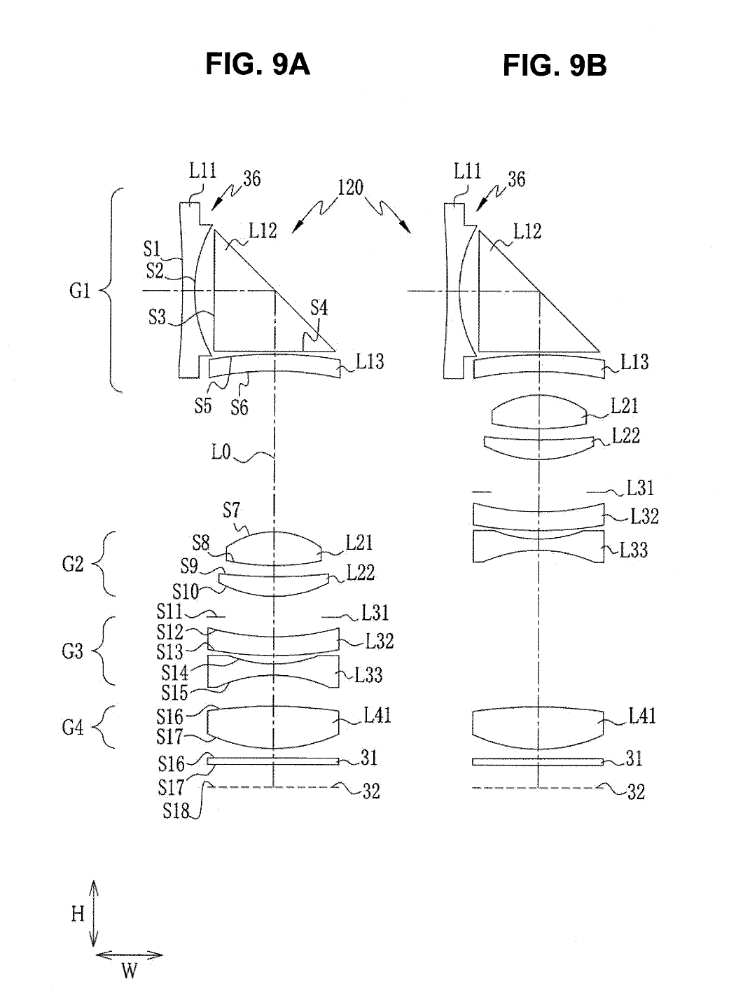

Example 2 is preferable in a case where a notch is formed on the prism side of the negative lens, which is disposed in the front of the prism, in a circular shape along the outer periphery thereof, and the stationary lens is disposed just behind the prism. As shown in FIGS. 9A and 9B, the photographic lens 120 according to Example 2 includes four lens groups of the first to fourth lens groups G1 to G4. FIG. 9A shows arrangement of the lens groups G1 to G4 at the wide-angle end, and FIG. 9B shows arrangement of the lens groups G1 to G4 at the telephoto end. Further, Table 4 shows lens data of the photographic lens 120 according to Example 2, Table 5 shows zoom data, and Table 6 shows aspheric surface coefficients.

TABLE 4
EXAMPLE 2 • BASIC LENS DATA

| | Ri | Di | Nd | νd |
|---|---|---|---|---|
| Si | (RADIUS | (ON-AXIS | (REFRAC- | ABBE |
| (SURFACE | OF CUR- | SURFACE | TIVE | NUM- |
| NUMBER) | VATURE) | SPACING) | INDEX) | BER) |
| 1 | −9.7898 | 0.13 | 1.61340 | 44.3 |
| 2 | 1.4016 | 0.21 | | |
| 3 | ∞ | 1.30 | 1.88300 | 40.8 |
| 4 | ∞ | 0.03 | | |
| *5 | 4.2372 | 0.18 | 1.50957 | 56.5 |
| *6 | 3.3805 | D6 | | |
| | | (VARIABLE) | | |
| *7 | 0.8464 | 0.36 | 1.47136 | 76 6 |
| *8 | −2.4453 | 0.12 | | |
| 9 | −5.2922 | 0.21 | 1.43875 | 94.9 |
| 10 | −1.239 | D10 | | |
| | | (VARIABLE) | | |
| 11 (APERTURE | ∞ | 0.21 | | |
| STOP) | | | | |
| *12 | −2.6279 | 0.20 | 1.62041 | 60.3 |
| *13 | −4.0223 | 0.09 | | |
| 14 | −1.3146 | 0.12 | 1.80808 | 22.8 |
| 15 | 1.4595 | D15 | | |
| | | (VARIABLE) | | |
| *16 | 4.8009 | 0.45 | 1.92285 | 18.9 |
| *17 | −1.6574 | 0.10 | | |
| 18 | ∞ | 0.07 | 1.51680 | 64.2 |
| 19 | ∞ | 0.24 | | |

(*ASPHERIC SURFACE)

TABLE 5
EXAMPLE 2 • ZOOM DATA

| | f | FNo. | 2ω | D6 | D10 | D15 |
|---|---|---|---|---|---|---|
| WIDE-ANGLE END | 1.00 | 2.99 | 65.9 | 1.72 | 0.22 | 0.33 |
| TELEPHOTO END | 2.85 | 5.57 | 23.8 | 0.25 | 0.35 | 1.67 |

TABLE 6
EXAMPLE 2 • ASPHERC SURFACE DATA

| ASPHERIC | | | | |
|---|---|---|---|---|
| SURFACE | | | | |
| COEFFICIENT | L12 | L21 | L31 | L41 |
| | FIFTH SURFACE(S5) | SEVENTH SURFACE(S7) | TWELFTH SURFACE(S12) | SIXTEENTH SURFACE(S16) |
| KA | 0.9999996 | 0.9988229 | 1.0007645 | 1.0000113 |
| RA₃ | — | — | −3.8027321E−04 | — |
| RA₄ | −2.136838E−04 | −1.5587465E−01 | 7.5697237E−01 | 1.6152360E−01 |
| RA₅ | — | — | 2.9522271E+00 | — |
| RA₆ | −3.0513780E−01 | 5.6259446E−01 | −4.2088730E+00 | 1.0600593E−01 |
| RA₇ | — | — | −2.1817121E+01 | — |
| RA₈ | 2.2297625E−01 | −2.3718804E+00 | −2.3061397E+01 | −4.2081822E−01 |
| RA₉ | — | — | 7.8166884E+01 | — |
| RA₁₀ | 4.3409885E−02 | 8.2423492E+00 | 4.7387240E+02 | 3.6545411E−01 |
| | SIXTH SURFACE(S6) | EIGHTH SURFACE(S8) | THIRTEENTH SURFACE(S13) | SEVENTEENTH SURFACE(S17) |
| KA | 0.9999934 | 0.9994581 | 0.9932956 | 0.9975946 |
| RA₃ | — | — | −9.5582680E−02 | — |
| RA₄ | −1.0280793E−02 | 3.3842037E−01 | 2.2484271E+00 | 4.8429768E−01 |
| RA₅ | — | — | −2.3342890E−01 | — |
| RA₆ | −3.4954324E−01 | 7.8024609E−01 | −7.2036046E+00 | −2.2707285E−01 |
| RA₇ | — | — | −3.6840984E−01 | — |
| RA₈ | 4.0547609E−01 | −2.6215628E+00 | 2.8912604E+01 | −4.3167573E−01 |
| RA₉ | — | — | 6.4622020E+01 | — |
| RA₁₀ | −6.2460922E−02 | 1.1796419E+01 | 9.3002771E+01 | 5.4433866E−01 |

As shown in FIGS. 9A and 9B and Tables 4 to 6, the first lens group G1 includes, in order from the subject side, three elements of: a lens L11 which has a negative refractive power; a prism L12; and a lens L13 which has a negative refractive power, and the refractive power of the first lens group G1 is negative as a whole. The notch 36 is formed on the prism L12 side of the lens L11 in a circular shape along the outer periphery thereof. Further, the first lens group G1 is a stationary lens group, and the lens L11, the prism L12, and the lens L13 are disposed to remain stationary relative to the optical axis L0.

The second lens group G2 is disposed in the rear of the lens L13, and includes two lenses of the lenses L21 and L22 which are disposed in order from the subject side. All the refractive powers of the lenses L21 and L22 are positive. Hence, the refractive power of the second lens group G2 is positive as a whole. Further, the second lens group G2 is a movable lens group which is provided to be movable along the optical axis L0. At the wide-angle end, the second lens group G2 is moved to the position closest to the image side, and at the telephoto end, it is moved to the position closest to the lens L13.

The third lens group G3 includes, in order from the subject side, three elements of: an aperture stop L31; and lenses L32 and L33 which have negative refractive powers. Hence, the refractive power of the third lens group G3 is negative as a whole. Further, the third lens group G3 is a movable lens group which is provided to be movable along the optical axis L0. At the wide-angle end, the third lens group G3 is moved to the position closest to the image side, and at the telephoto end, it is moved to the position closest to the lens L13.

The fourth lens group G4 includes a lens L41 which has a positive refractive power. Hence, the refractive power of the fourth lens group G4 is positive. Further, the fourth lens group G4 is a stationary lens group, and the lens L41 is disposed to remain stationary relative to the optical axis L0.

### Example 3

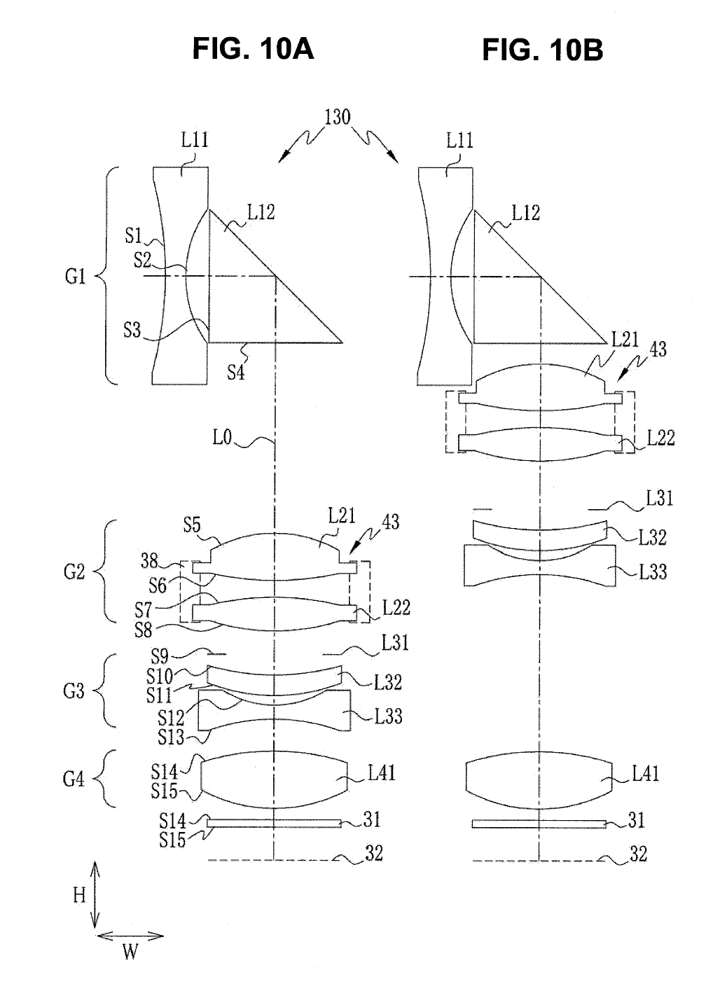

Example 3 is preferable in a case where a notch is formed on the prism side of the lens, which is disposed in the rear of the prism, in a circular shape along the outer periphery thereof, and the movable lens is disposed just behind the prism. As shown in FIGS. 10A and 10B, the photographic lens 130 according to Example 3 includes the first to fourth lens groups G1 to G4. FIG. 10A shows arrangement of the lens groups G1 to G4 at the wide-angle end, and FIG. 10B shows arrangement of the lens groups G1 to G4 at the telephoto end. Further, Table 7 shows lens data of the photographic lens 130 according to Example 3, Table 8 shows zoom data, and Table 9 shows aspheric surface coefficients.

TABLE 7
EXAMPLE 3 • BASIC LENS DATA

| | Ri | Di | Nd | νd |
|---|---|---|---|---|
| Si | (RADIUS | (ON-AXIS | (REFRAC- | ABBE |
| (SURFACE | OF CUR- | SURFACE | TIVE | NUM- |
| NUMBER) | VATURE) | SPACING) | INDEX) | BER) |
| *1 | −4.0557 | 0.22 | 1.51537 | 63.3 |
| *2 | 1.2512 | 0.25 | | |
| 3 | ∞ | 1.43 | 1.78590 | 44.2 |
| 4 | ∞ | D4 | | |
| | | (VARIABLE) | | |
| *5 | 1.3636 | 0.50 | 1.47136 | 76.6 |
| *6 | −3.0923 | 0.18 | | |
| 7 | 2.9832 | 0.36 | 1.49700 | 81.5 |
| 8 | −2.2469 | D8 | | |
| | | (VARIABLE) | | |
| 9 (APERTURE | ∞ | 0.22 | | |
| STOP) | | | | |
| *10 | −2.5456 | 0.22 | 1.62041 | 60.3 |
| *11 | −1.9376 | 0.10 | | |
| 12 | −1.0449 | 0.15 | 1.84665 | 23.8 |
| 13 | 2.0870 | D13 | | |
| | | (VARIABLE) | | |
| *14 | 2.5523 | 0.61 | 1.80348 | 40.4 |
| *15 | −1.6409 | 0.12 | | |
| 16 | ∞ | 0.08 | 1.51680 | 64.2 |
| 17 | ∞ | 0.35 | | |

(*ASPHERIC SURFACE)

TABLE 8
EXAMPLE 3 • ZOOM DATA

| | f | FNo. | 2ω | D4 | D8 | D13 |
|---|---|---|---|---|---|---|
| WIDE-ANGLE END | 1.00 | 3.19 | 65.4 | 2.04 | 0.25 | 0.34 |
| TELEPHOTO END | 2.85 | 5.38 | 23.5 | 0.22 | 0.52 | 1.90 |

TABLE 9
EXAMPLE 3 • ASPHERIC SURFACE DATA

| ASPHERIC | | | | |
|---|---|---|---|---|
| SURFACE | | | | |
| COEFFICIENT | L11 | L21 | L31 | L41 |
| | FIRST SURFACE(S1) | FIFTH SURFACE(S5) | TENTH SUSFACE(S10) | FOURTEENTH SUSFACE(S14) |
| KA | 1.0001666 | 0.9907273 | 1.0005173 | 0.9999427 |
| RA₃ | — | — | 1.3302361E−02 | — |
| RA₄ | −8.4510295E−03 | −1.1716908E−01 | 1.2739497E+00 | −4.2503801E−02 |
| RA₅ | — | — | 2.0284463E+00 | — |
| RA₆ | −5.3683766E−02 | −1.0858031E−01 | −1.3580951E+00 | 2.1657029E−01 |
| RA₇ | — | — | −9.4459340E−00 | — |
| RA₈ | 4.2524692E−02 | −1.2540591E−01 | −1.2395777E+01 | −3.7510117E−01 |
| RA₉ | — | — | 1.5773100E+01 | — |
| RA₁₀ | −1.1697462E−02 | −2.5784641E−02 | 1.1819444E+02 | 2.1805546E−01 |
| | SECOND SURFACE(S2) | SIXTH SURFACE(S6) | ELEVENTH SURFACE(S11) | FIFTEENTH SURFACE(S15) |
| KA | 0.9499838 | 1.0011850 | 0.9935698 | 0.9973712 |
| RA₃ | — | — | −1.0383905E−02 | — |
| RA₄ | −9.7041848E−02 | 4.2619723E−02 | 1.9358602E+00 | 9.8591472E−02 |
| RA₅ | — | — | 1.2951087E+00 | — |
| RA₆ | −1.6198306E−01 | −6.4547667E−02 | −1.6674280E+00 | 2.3447973E−01 |
| RA₇ | — | — | 4.5716131E−02 | — |
| RA₈ | 9.9173413E−02 | −3.9910264E−01 | 5.7623189E+00 | −5.1349571E−01 |
| RA₉ | — | — | 4.3396542E+00 | — |
| RA₁₀ | −3.1493231E−02 | 6.3459499E−01 | −2.2449249E+01 | 3.1644951E−01 |

As shown in FIGS. 10A and 10B and Tables 7 to 9, the first lens group G1 includes, in order from the subject side, two elements of: a lens L11 which has a negative refractive power; and a prism L12, and the refractive power of the first lens group G1 is negative as a whole. Further, the first lens group G1 is a stationary lens group, and the lens L11 and the prism L12 are disposed to remain stationary relative to the optical axis L0.

The second lens group G2 includes two lenses of the lenses L21 and L22 which are disposed in the rear of the prism L12. All the refractive powers of the lenses L21 and L22 are positive. Hence, the refractive power of the second lens group G2 is positive as a whole. The notch 43 is formed on the prism L12 side of the lens L21 in a circular shape along the outer periphery thereof. Further, the second lens group G2 is a movable lens group which is provided to be movable along the optical axis L0. At the wide-angle end, the second lens group G2 is moved to the position closest to the image side, and at the telephoto end, it is moved to the position closest to the prism L12.

The third lens group G3 includes, in order from the subject side, three elements of: an aperture stop L31; a lens L32 which has a positive refractive power; and a lens L33 which has a negative refractive power, and the refractive power of the third lens group G3 is negative as a whole. Further, the third lens group G3 is a movable lens group which is provided to be movable along the optical axis L0. At the wide-angle end, the third lens group G3 is moved to the position closest to the image side, and at the telephoto end, it is moved to the position closest to the prism L12 side. By being moved as described above, the third lens group G3 takes charge of zooming of the photographic lens 130 together with the second lens group G2.

The fourth lens group G4 includes a lens L41 which has a positive refractive power. Hence, the refractive power of the fourth lens group G4 is positive. Further, the fourth lens group G4 is a stationary lens group, and the lens L41 is disposed to remain stationary relative to the optical axis L0.

### Example 4

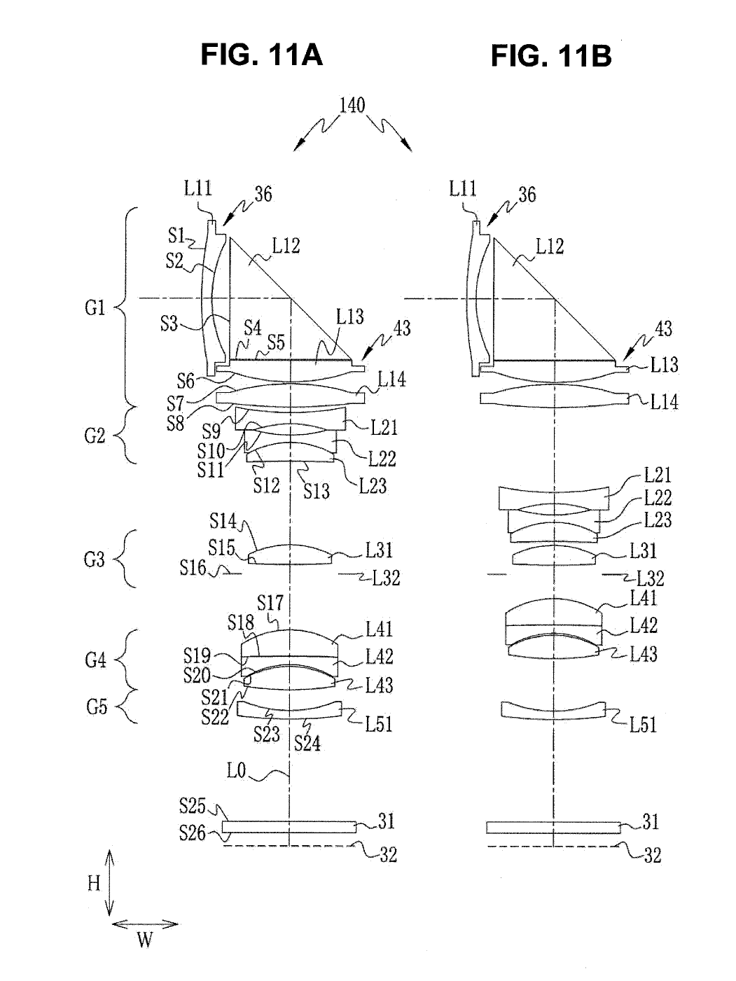

In Example 4, notches are formed on the prism sides of both lenses, which are disposed in the front and the rear of the prism, in circular shapes along the outer peripheries of those, and a plurality of stationary lenses is disposed just behind the prism. As shown in FIGS. 11A and 11B, the photographic lens 140 according to Example 4 includes the first to fifth lens groups G1 to G5. FIG. 11A shows arrangement of the lens groups G1 to G5 at the wide-angle end, and FIG. 11B shows arrangement of the lens groups G1 to G5 at the telephoto end. Further, Table 10 shows lens data of the photographic lens 140 according to Example 4, Table 11 shows zoom data, and Table 12 shows aspheric surface coefficients.

TABLE 10
EXAMPLE 4 • BASIC LENS DATA

| | Ri | Di | Nd | νd |
|---|---|---|---|---|
| Si | (RADIUS | (ON-AXIS | (REFRAC- | ABBE |
| (SURFACE | OF CUR- | SURFACE | TIVE | NUM- |
| NUMBER) | VATURE) | SPACING) | INDEX) | BER) |
| 1 | 3.8528 | 0.10 | 2.00068 | 25.5 |
| 2 | 1.3592 | 0.19 | | |
| 3 | ∞ | 1.31 | 1.88300 | 40.8 |
| 4 | ∞ | 0.01 | | |
| 5 | ∞ | 0.23 | 1.49700 | 81.6 |
| 6 | −1.9786 | 0.02 | | |
| *7 | 2.2760 | 0.25 | 1.69098 | 52.9 |
| *8 | −5.2984 | D8 | | |
| | | (VARIABLE) | | |
| *9 | −2 9699 | 0.12 | 1.509568 | 56.5 |
| *10 | 1.2017 | 0.12 | | |
| 11 | −1.4786 | 0.08 | 1.803996 | 46.6 |
| 12 | 0.9206 | 0.20 | 1.846653 | 23.8 |
| 13 | 13.7366 | D13 | | |
| | | (VARIABLE) | | |
| *14 | 0.9882 | 0.21 | 1.509568 | 56.5 |
| *15 | −11.1893 | 0.10 | | |
| 16 (APERTURE | ∞ | D16 | | |
| STOP) | | | | |
| 17 | 0.9336 | 0.28 | 1.617998 | 63.3 |
| 18 | 14.0947 | 0.00 | | |
| 19 | 14.0947 | 0 09 | 1.846653 | 23.8 |
| 20 | 0.8957 | 0.02 | | |
| *21 | 0.9695 | 0.25 | 1.50957 | 56.5 |
| *22 | −2.9541 | D22 | | |
| | | (VARIABLE) | | |
| 23 | −1.3083 | 0.09 | 1.48749 | 70.4 |
| 24 | −4.3874 | 1.09 | | 64.2 |
| 25 | ∞ | 0.12 | 1.51680 | |
| 26 | ∞ | 0.14 | | |

(*ASPHERIC SURFACE)

TABLE 11
EXAMPLE 4 • ZOOM DATA

| | f | FNo. | 2ω | D8 | D13 | D16 | D22 |
|---|---|---|---|---|---|---|---|
| WIDE-ANGLE END | 1.00 | 3.70 | 64.0 | 0.06 | 0.89 | 0.60 | 0.22 |
| TELEPHOTO END | 2.75 | 4.16 | 23.3 | 0.91 | 0.04 | 0.26 | 0.56 |

TABLE 12
EXAMPLE 4 • ASPHERIC SURFACE DATA

| ASPHERIC | | | | |
|---|---|---|---|---|
| SURFACE | | | | |
| COEFFICIENT | L14 | L21 | L31 | L43 |
| | SEVENTH SURFACE(S7) | NINTH SURFACE(S9) | FOURTEENTH SURFACE(S14) | TWENTY-FIRST SURFACE(S16) |
| KA | 0.4777641 | −144.5106318 | 0.6271560 | 0.0894493 |
| RA₃ | −2.8347308E−02 | — | — | −5.8742362E−02 |
| RA₄ | −5.2910986E−03 | −2.2315522E−01 | 3.7911903E−02 | 4.5232889E−01 |
| RA₅ | −1.8854203E−01 | — | — | −4.5076676E−01 |
| RA₆ | −3.2568726E−02 | 1.8225782E+00 | 5.5318713E−03 | −6.3124147E−01 |
| RA₇ | 1.1281835E−01 | — | — | 5.0247777E−01 |
| RA₈ | −3.2710893E−02 | −8.9677456E+00 | 2.0044126E+00 | 6.2696824E+00 |
| RA₉ | −4.2184178E−01 | — | — | 9.1878042E+00 |
| RA₁₀ | −8.3550236E−01 | 1.8150596E+01 | 2.0657314E+00 | 9.3796432E−01 |
| RA₁₁ | −6.8520091E−01 | — | — | −1.3433810E+02 |
| RA₁₂ | −4.0104267E−02 | — | — | 1.8113743E+02 |
| RA₁₃ | 1.8517861E+00 | — | — | — |
| RA₁₄ | 2.5844210E+00 | — | — | — |
| RA₁₅ | 2.6641689E−01 | — | — | — |
| RA₁₆ | −1.0805682E+01 | — | — | — |
| | EIGHTH SURFACE(S8) | TENTH SURFACE(S6) | FIFTEENTH SURFACE(S13) | WENTY-SECOND SURFACE(S17) |
| KA | 32.0624972 | 7.1547829 | −1635.3492360 | −50.9639507 |
| RA₃ | −2.1020679E−02 | — | — | −1.1112736E−01 |
| RA₄ | −6.9916210E−02 | 1.7719134E−02 | 3.0502761E−02 | 7.3155966E−01 |
| RA₅ | −1.5282359E−02 | — | — | −9.3340408E−01 |
| RA₆ | −1.2253557E−01 | −3.4252984E+00 | 6.2892898E−01 | 4.8558881E−01 |
| RA₇ | −1.2527342E−01 | — | — | 3.2089035E−01 |
| RA₈ | 6.2310604E−03 | 1.0186277E+01 | −6.2943396E−01 | 9.2385348E+00 |
| RA₉ | 1.2003432E−01 | — | — | −7.3312338E+00 |
| RA₁₀ | −2.4783580E−01 | −7.2293207E+01 | 9.0518022E+00 | 2.6308466E+00 |
| RA₁₁ | −8.0211905E−01 | — | — | — |
| RA₁₂ | −1.2900587E+00 | — | — | — |
| RA₁₃ | 2.1301733E−01 | — | — | — |
| RA₁₄ | 8.1642925E−01 | — | — | — |
| RA₁₅ | 5.4717013E+00 | — | — | — |
| RA₁₆ | −5.4348755E+00 | — | — | — |

As shown in FIGS. 11A and 11B and Tables 10 to 12, the first lens group G1 includes, in order from the subject side, four elements of: a lens L11 which has a negative refractive power; a prism L12; and lenses L13 and L14 which have positive refractive powers, and the refractive power of the first lens group G1 is positive as a whole. The notch 36 is formed on the prism L12 side of the lens L11 in a circular shape along the outer periphery thereof. In addition, the notch 43 is formed on the outer peripheral portion of the prism L12 side of the lens L13 in the same shape. Further, the first lens group G1 is a stationary lens group, and the lenses L11, L13, and L14 and the prism L12 are disposed to remain stationary relative to the optical axis L0.

The second lens group G2 is disposed in the rear of the lens L14, and includes, in order from the subject side: a lens L21 which has a negative refractive power; and a cemented lens which is formed by cementing a lens L2 2 having a negative refractive power and a lens L23 having a positive refractive power at the surface S12. The refractive power of the second lens group G2 is negative as a whole. Further, the second lens group G2 is a movable lens group which is provided to be movable along the optical axis L0. At the wide-angle end, the second lens group G2 is moved to the position closest to the subject side, and at the telephoto end, it is moved to the position closest to the image side.

The third lens group G3 includes, in order from the subject side, two elements of: a lens L31 which has a positive refractive power; and an aperture stop L32. Hence, the refractive power of the third lens group G3 is positive as a whole. Further, the third lens group G3 is a stationary lens group, and the lens L31 and the aperture stop L32 are disposed to remain stationary relative to the optical axis L0.

The fourth lens group G4 includes, in order from the subject side: a lens L41 which has a positive refractive power; a lens L42 which has a negative refractive power; and a lens L43 which has a positive refractive power, and the refractive power of the fourth lens group G4 is positive as a whole. Further, the fourth lens group G4 is a movable lens group which is provided to be movable along the optical axis L0. At the wide-angle end, the fourth lens group G4 is moved to the position closest to the image side, and at the telephoto end, it is moved to the position closest to the subject side.

The fifth lens group G5 includes a lens L51 which has a negative refractive power. Hence, the refractive power of the fifth lens group G5 is negative. Further, the fifth lens group G5 is a stationary lens group, and the lens L51 is disposed to remain stationary relative to the optical axis L0.

Furthermore, in the above-mentioned Examples 1 to 4, description has been given of the example in which the notch is formed on the outer peripheral portion of the lens disposed to be adjacent to the front side and the rear side of the prism L12. However, the lens, which is disposed in the rear of the prism L12, may be formed in a non-rotationally symmetric shape such as an oval shape by appropriately cutting off the portion, through which rays of the photographic screen do not pass, therefrom in accordance with the thickness W of the digital camera 11. Further, the lens L11, which is disposed to be closest to the subject side, may also be formed in a non-rotationally symmetric shape such as an oval shape and a rectangular shape in accordance with the photographic screen.

Furthermore, in the above-mentioned embodiments and examples, description is given of the example in which the optical path is deflected by the prism, but a reflective mirror may be used instead of the prism.

What is claimed is:

1. A zoom lens that deflects an optical path by using a reflective member and performs zooming by moving a lens group disposed in the rear of the reflective member,
wherein a notch is formed on a reflective member side of a lens adjacent to the reflective member along an outer periphery of the lens.

2. The zoom lens according to claim 1, wherein the notch is formed on the lens which is disposed to be adjacent to the front of the reflective member.

3. The zoom lens according to claim 1, wherein the notch is formed on the lens which is disposed to be adjacent to the rear of the reflective member.

4. The zoom lens according to claim 1, wherein only one negative lens is disposed in the front of the reflective member.

5. The zoom lens according to claim 1,
wherein the zoom lens comprises a first lens group that includes the reflective member and a stationary lens which is disposed to remain stationary relative to an optical axis and is positioned to be closest to a subject side, and
wherein the first lens group has a negative refractive power as a whole.

6. The zoom lens according to claim 1,
wherein the zoom lens comprises a second lens group that is provided in the rear of the reflective member so as to be movable relative to an optical axis, and
wherein the second lens group has a positive refractive power as a whole.

7. The zoom lens according to claim 1,
wherein a photographic screen is rectangular, and
wherein the reflective member deflects the optical path in a direction perpendicular to short sides of the photographic screen.

8. The zoom lens according to claim 1,
wherein a photographic screen is rectangular, and
wherein the zoom lens comprises a lens of which an outer peripheral portion is cut off along sides of a photographic screen, and is formed in a non-rotationally symmetric shape.

9. The zoom lens according to claim 1,
wherein the zoom lens comprises, in order from a subject side:
a first lens group that has a negative refractive power and includes the reflective member;
a second lens group that has a positive refractive index;
a third lens group that has a negative refractive power; and
a fourth lens group that has a positive refractive index, and
wherein zooming is performed by moving the second lens group and the third lens group along an optical axis.

10. An image pickup apparatus comprising the zoom lens according to any one of claims 1 to 9.
